(19) United States
(12) Patent Application Publication
(10) Pub. No.: US 2011/0036195 A1
(43) Pub. Date: Feb. 17, 2011

(54) GEARSHIFT HOUSING OF A VEHICLE WITH A SELECTOR LEVER AND METHOD FOR MOUNTING THE SELECTOR LEVER ON THE GEARSHIFT HOUSING

(75) Inventors: Sascha BRUDER, Mainz (DE); Thorsten HAHN, Gau-Odernheim (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/855,518

(22) Filed: Aug. 12, 2010

(30) Foreign Application Priority Data
Aug. 13, 2009 (DE) 102009037067.6

(51) Int. Cl. F16H 63/30; B23P 11/00

(52) U.S. Cl. 74/473.33; 29/428

(57) ABSTRACT

A gearshift housing of a vehicle is provided with a selector lever and a method is provided for mounting the selector lever on the gearshift housing. The selector lever transmits selection movements of a selector finger of a gearshift lever to pulling and/or pushing movements of a selector cable control. In the process, the selector lever pivots about a fulcrum in different selection positions. To this end, a cast-on bearing pin is provided on the gearshift housing, on which the selector lever is rotatably mounted.

### CROSS-REFERENCE TO RELATED APPLICATION

This application claims priority to German Patent Application No. 102009037067.6, filed Aug. 13, 2009, which is incorporated herein by reference in its entirety.

### TECHNICAL FIELD

The invention relates to a gearshift housing of a vehicle with a selector lever and a method for mounting the selector lever on the gearshift housing. The selector lever transmits selection movements of a selector finger of a gearshift lever to pulling and/or pushing movements of a selector cable control. The selector lever thereby pivots about a fulcrum in different selection positions.

### BACKGROUND

A gearshift housing for a gearshift mechanism of a manually operated transmission is known from the publication U.S. Pat. No. 4,633,728. The manually operated transmission comprises a plurality of forward gears and a reverse gear and has a gearshift shaft below the manual gearshift lever. A selector finger, which is fixed on the gearshift shaft, lies within a system of interconnected slots in a guide plate, which is mounted on the gearshift housing. The movement of the gearshift lever causes the selector finger to move within the restricted path defined by the slots. A pawl, which is supported by the surface of the guide plate, is pivotally mounted in a slotted opening which permits linear displacement with respect to the pivot finger.

A torsion spring exerts a continuous spring force on the slotted opening in order to hold the pawl in a normal position, in which it prevents a movement of the selector mechanism from a forward gear position directly into a reverse gear position. The device exerts a force on the selector mechanism so that a movement from the selector finger into the reverse gear position is prevented. But it makes possible bringing the gearshift from a neutral plane into the reverse gear position. The pawl prevents a movement of the selector mechanism from the forward gear position, which lies in the same plane of the reverse position, and provides a guide surface along which the selector mechanism moves from the highest forward gear into the lowest gear.

Such a gearshift mechanism has the disadvantage of a high number of different components which have to interact for the functioning of the gearshift. Through the multiplicity of individual components of the gearshift mechanism according to the prior art a longer mounting time also has to be calculated accordingly and finally storage costs are added, which grow with the number of components of the manual transmission.

A cost-intensive detail of a conventional gearshift mechanism is shown by FIG. 3. This expanded schematic view shows a selector lever 2, which transmits selection movements of a selector finger of a gearshift lever which is not shown to pulling and pushing movements of a selector cable control. The selector cable control to this end is connected to a connecting pin 13 in form of a ball pin 17, wherein the selector lever 2 is connected in a fixed manner to a selector shaft 18 in a fulcrum 4. The selector shaft 18 is rotatably arranged in two slide bearings 19 and 20 of the gearshift housing 22. Accordingly, the preassembly of the selector shaft 18 with the selector lever 2 in the fulcrum 4 as well as the provision and manufacturing of the selector shaft bearings 19 and 20 of the gearshift housing 22 is cost-intensive both with respect to the manufacturing costs as well as with respect to the assembly costs.

At least one object of the invention is to create a gearshift housing of a vehicle with a selector lever and a method for mounting the selector lever on the gearshift housing, which both with respect to the storage costs as well as with respect to the components to be provided makes possible cost saving and simultaneously improves the safety of the overall design of the gearshift housing. Furthermore, other objects, desirable features, and characteristics will become apparent from the subsequent summary and detailed description, and the appended claims, taken in conjunction with the accompanying drawings and this background.

### SUMMARY

According to an embodiment of the invention, a gearshift housing of a vehicle with a selector lever and a method for mounting the selector lever on the gearshift housing is created. The selector lever transmits selection movement of a selector finger of a gearshift lever upon pulling and/or pushing movement of a selector cable control. The selector lever thereby pivots about a fulcrum in different selection positions. To this end, a bearing pin cast onto the gearshift housing is provided, on which the selector lever is rotatably mounted.

This embodiment of the invention has the advantage that such a bearing pin can be completed in one operation with the injection molding of the gearshift housing, without reworking of slide bearings becoming necessary as with the slide bearings used for the selector shaft usual in the prior art. In addition, the advantage that with the bearing pin fixing of a selector shaft with a selector lever is completely obsolete, more so since the selector lever now has a bearing bore which is adapted to the bearing pin, wherein in a preferred embodiment of the invention a bearing bush is additionally provided between bearing pin and bearing bore of the selector lever.

The material of the gearshift housing and the selector lever can be a fiber-reinforced plastic. Preferentially a polyamide with glass-fiber reinforcement is provided, without materials of the same type sliding on each other, since improved sliding of the bearing bush of a different plastic material such as polytetrafluoroethylene for example can be ensured. Thus, compared with the prior art, improvement is also achieved in the longevity of this mounting of the selector lever on the gearshift housing.

Beyond this, the gearshift housing is significantly simplified more so since no selector shaft slide bearings have to be provided any longer. In addition, the length of the bearing pin can be embodied clearly shortened compared with the length of a selector shaft.

In a further embodiment of the invention the cast-on bearing pin is fixed on an axial contact surface of the gearshift housing with its cast-on end. This contact surface also serves to achieve axial securing through the bearing bush. To this end, the free end of the bearing pin comprises a ring groove in which for example a locking circlip can engage in order to lock the bearing bush and selector lever in axial direction without impeding the rotary movements of the selector lever.

In addition, it is provided that the selector lever in the fulcrum comprises a bearing bore for the pivotable mounting on the bearing pin and the bearing bore comprises a shoulder to a diameter larger than the bearing bore. This shoulder can contribute to the axial securing of the selector lever on the cast-on bearing pin.

In addition, the selector lever comprises a bore spaced from the fulcrum of the selector lever for accommodating the selector finger, which interacts with a gearshift lever and thus transmits the selection position to the selector lever. Furthermore, the selector lever comprises a connecting pin spaced from the fulcrum of the selector lever and from the mounting bore for the selector finger in order to make possible the connection of the selector cable control.

In order to transmit the forces upon pivoting the selector lever about the bearing pin the selector lever is constructed of a fiber-reinforced plastic with reinforcement ribs in regions subject to high loading. Since this fiber-reinforced plastic such as for example polyamide can be produced with glass fibers through an injection molding method, the selector lever can be manufacture clearly more cost-effectively than a metal selector lever as is known from the prior art.

As already mentioned above, a bearing bush is arranged between the bearing bore of the selector lever and the cast-on bearing pin. As already mentioned above, the bearing bush, through a circlip in the ring groove of the bearing pin, can axially lock both the selector lever as well as the bearing bush, however the bearing bush used in this embodiment of the invention comprises internal snap hooks which engage in the ring groove and external snap hooks which are in engagement with the shoulder in the bearing bore of the selector angle. In addition, this special bearing bush comprises a flange-shaped collar which supports itself with respect to the axial contact service of the gearshift housing by means of spring elements, which secure axial locking of the inner snap hooks as well as the outer snap hooks. Thus, no additional axial locking circlips are required with this embodiment of the invention.

In addition to this, a spring element supports itself on the gearshift housing in such a manner that the selector lever and, via the selector finger, the gearshift lever are held in a neutral position.

A method for the mounting of the selector lever on the gearshift housing comprises the following method steps. Initially, a gearshift housing is produced with a cast-on bearing pin for the pivotable mounting of the selector lever on the gearshift housing. In addition, a bearing bush, which can be fitted into a bearing bore of the selector lever, is manufactured. The bearing bush can then be fitted into the bearing bore of the selector lever. Following this, the selector lever with bearing bush is fitted onto the cast-on bearing pin of the gearshift housing while simultaneously accommodating a selector finger of a gearshift lever in a mounting bore of the selector lever. Finally, attachment of a selector cable control to a connecting pin of the selector lever can take place.

With this method and these method steps the assembly time of the selector lever compared with the assembly of the conventional selector lever with a selector shaft fixed to the selector lever and the fitting of this selector shaft in suitably prepared slide bearings of the gearshift housing is significantly shortened.

To this end, the bearing pin is cast with one end onto an axial contact surface of the gearshift housing. In addition to this, a bore for accommodating a selector finger of the gearshift lever is provided in the selector lever on the one hand and a connecting pin for connecting a selector cable control on the other hand, and this connecting pin can likewise be cast onto the selector lever. To improve the lifespan and the stability of the bearing pin the gearshift housing is reinforced in the region of the cast-on bearing pin.

### BRIEF DESCRIPTION OF THE DRAWINGS

The present invention will hereinafter be described in conjunction with the following drawing figures, wherein like numerals denote like elements, and.

FIG. 1 shows a schematic expanded perspective view of a gearshift housing with a selector lever to be mounted on a bearing pin;

FIG. 2 shows a schematic expanded perspective view of a gearshift housing according to FIG. 1 from a changed perspective; and

FIG. 3 shows a schematic expanded perspective view of a gearshift housing with a selector lever and a selector shaft according to the prior art.

### DETAILED DESCRIPTION

The following detailed description is merely exemplary in nature and is not intended to limit application and uses. Furthermore, there is no intention to be bound by any theory presented in the preceding background or summary or the following detailed description.

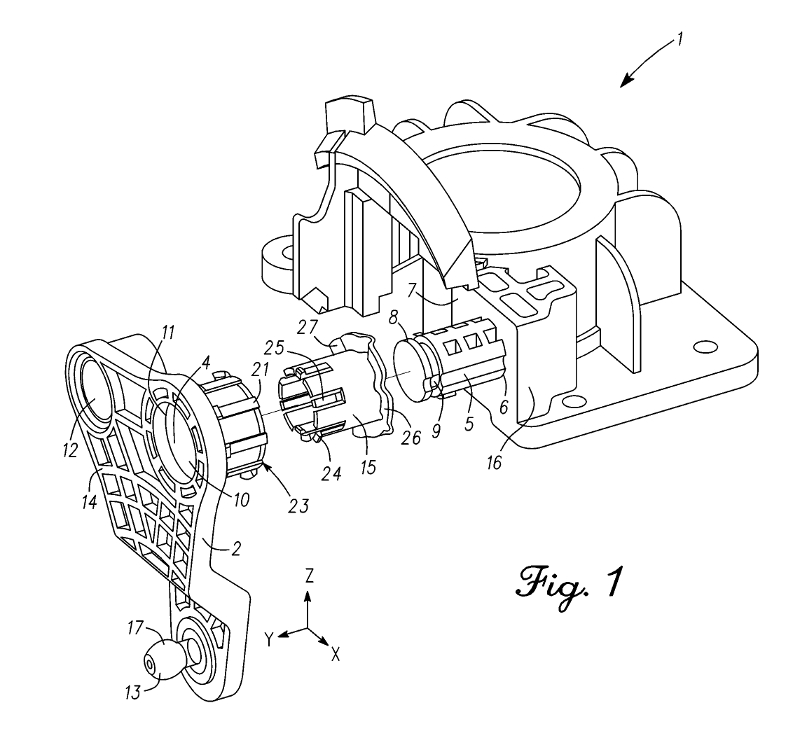

FIG. 1 shows a schematic perspective expanded view of a gearshift housing 1 with a selector lever 2 to be mounted on a bearing pin 5. The selector lever 2 transmits selection movement of a selector finger of a gearshift lever that is not shown to pulling and/or pushing movements of a selector cable control which is not shown, wherein the selector finger is accommodated by the bore 12 of the selector lever 2 and the selector cable control is articulated on a ball pin 17. This ball pin 17 can also be designed as cylindrical connecting pin 13 for the selector cable control.

For transmitting the deflection of the selector finger to the selector cable control, the selector lever 2 can be pivoted on the bearing pin 5 about a fulcrum 4. To this end, the selector lever 2 for mounting on the bearing pin 5 comprises a tubular extension 23 of a bearing bore 10, wherein the tubular extension 23 comprises reinforcing ribs 21 in axial direction. In addition, the bearing bore comprises a shoulder 11 to a larger diameter than the bearing bore. This shoulder 11 serves for the axial fixing of the selector lever 2 on the bearing pin 5 of the gearshift housing 1 with the help of a bearing bush 15. The structure of the selector lever 2 comprises reinforcing ribs 14 in order to reinforce regions of the selector lever 2 which are subjected to high loads.

The bearing pin 5 of the gearshift housing 1 is cast on together with the gearshift housing 1 in one injection molding process and comprises a cast-on end 6 on an axial support surface 7 of the gearshift housing 1. A free end 8 of the bearing pin 5 comprises a ring groove 9 which serves for the axial fixing of the selector lever 2 pivotable on the bearing pin 5 with the help of the bearing bush 15. Since both the gearshift housing 1 as well as the selector lever 2 are injection-molded of a fiber-reinforced plastic the bearing bush 15 is provided of a plastic improving the slide bearing between the bearing pin 5 and the tubular extension 23 of the bearing bore 10 such as polytetrafluoroethylene so that rubbing of two fiber-reinforced plastic parts rubbing on top of each other is prevented. In order to connect the cast-on bearing pin 5 with the gearshift housing 1 in a mechanically stable manner the gearshift housing 1 comprises a reinforcing element 16 for the axial contact surface 7 in the region of the cast-on bearing pin 5.

To axially fix the selector lever 2 on the bearing pin 5 the bearing bush 15 comprises locking and spring elements to ensure that without additional circlips or other means of axial locking the selector lever with the bearing bush 15 is automatically locked axially on the bearing pin 5 when fitting the three components together. Outer snap hooks 24 and inner snap hooks 25 of the bearing bush 15 serve for this purpose, wherein the outer snap hooks 24 can be brought in engagement with the shoulder 11 of the bearing bore 10 and the inner snap hooks 25 can engage in the ring groove 9 of the bearing pin 5. A flange-like collar 26 of the bearing bush 15 additionally comprises spring elements 27 and 28, which resiliently axially preload and lock the inner snap hooks 25 and the outer snap hooks 26 in the ring groove and on the shoulder 11 respectively. Thus, the selector lever 2 remains axially locked on the bearing pin 5 by simply clicking together the snap hooks 24 and 25.

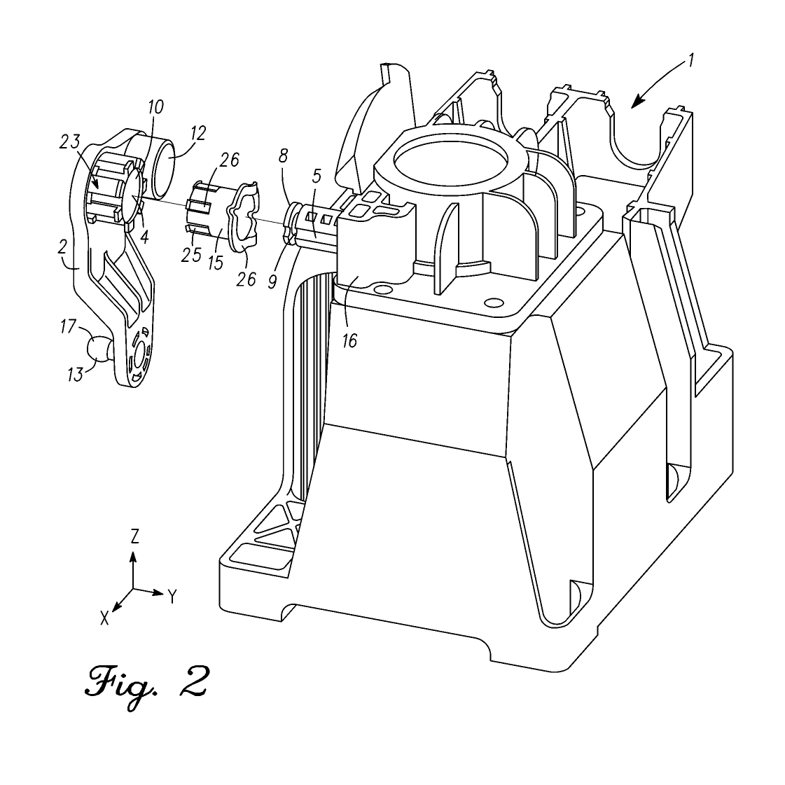

FIG. 2 shows a schematic expanded perspective view of a gearshift housing 1 according to FIG. 1 from a changed perspective. Components with same functions as in FIG. 1 are marked with same reference numbers and are not separately explained.

While the mounting bore 12 accommodates a selector finger of the gearshift lever of the vehicle, the bearing bore 10 of the selector lever 2 serves for the formation of a fulcrum 4 for the selector lever 2 on the cast-on bearing pin 5 of the gearshift housing 1. Here, the axial length of the tubular extension 23 of the bearing bore 10 corresponds to the axial length of the mounting bore 12 for the selector finger of the gearshift lever of the vehicle.

For assembling or attaching the selector lever 2 to the bearing pin 5 the bearing bush 15 is initially inserted in the bearing bore 10 of the selector lever 2 until the outer snap hooks 24 of the bearing bush 15 engage on the shoulder 11 in the bearing bore 10. After this, the selector lever 2 with the bearing bush 15 is pushed onto the bearing pin 5 until the inner snap hooks engage in the ring groove 9 of the bearing pin 5.

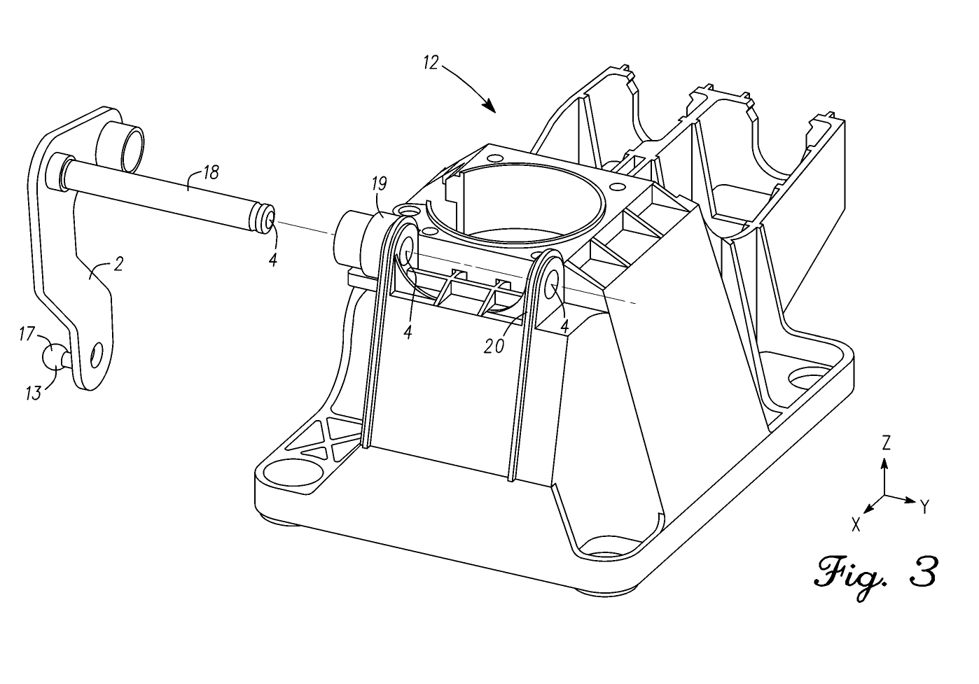

FIG. 3 shows a schematic perspective expanded view of a gearshift housing 22 with a selector lever 2 and a selector shaft 18 according to the prior art as already explained as introduction, so that renewed figure description of FIG. 3 is not required.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A gearshift housing of a vehicle, comprising:
a selector finger of a gearshift lever;
a selector lever adapted to transmit a selection movement of the selector finger of the gearshift lever to a pulling and pushing movement of a selector cable control and pivots about a fulcrum in different selection positions; and
a cast-on bearing pin on which the selector lever is rotatably mounted.

2. The gearshift housing according to claim 1, wherein the cast-on bearing pin with a cast-on end is substantially fixed on an axial contact surface of the gearshift housing.

3. The gearshift housing according to claim 1, wherein the cast-on bearing pin at a free end comprises a ring groove.

4. The gearshift housing according to claim 1, wherein the selector lever in the fulcrum comprises a bearing bore adapted to the pivotable mounting on the cast-on bearing pin, and wherein the bearing bore comprises a shoulder to a larger diameter than the bearing bore.

5. The gearshift housing according to claim 1, wherein the selector lever comprises a bore adapted to accommodate the selector finger.

6. The gearshift housing according to claim 1, wherein the selector lever comprises a connecting pin for connecting the selector cable control.

7. The gearshift housing according to claim 1, wherein the selector lever comprises a fiber-reinforced plastic with a plurality of reinforcing ribs in a plurality of regions subjected to high loads.

8. The gearshift housing according to claim 4, wherein a bearing brush is arranged between the bearing bore of the selector lever and the cast-on bearing pin a bearing bush.

9. The gearshift housing according to claim 1, wherein the cast-on bearing pin is cast onto the gearshift housing is connected to the gearshift housing with a reinforcing element.

10. The gearshift housing according to claim 1, wherein a spring element is self supported on the gearshift housing that the spring element is adapted to hold the selector lever and with the selector finger the gearshift lever in a neutral selection position.

11. A method for mounting a selector lever on a gearshift housing comprising the steps of:
manufacturing the gearshift housing with a cast-on bearing pin for a pivotable mounting of the selector lever on the gearshift housing;
manufacturing a bearing bush adapted to fit into a bearing bore of the selector lever;
fitting the bearing bush into the bearing bore of the selector lever;
fitting the selector lever with the bearing bush onto the cast-on bearing pin of the gearshift housing subject to substantially simultaneously accommodating a selector finger of a gearshift lever in a mounting bore of the selector lever; and
fastening a selector cable control to a connecting pin of the selector lever.

12. The method according to claim 11, further comprising the step of casting the cast-on bearing pin with an end onto an axial contact surface of the gearshift housing.

13. The method according to claim 11, further comprising the step of providing a bore in the selector lever that is adapted to accommodate the selector finger of the gearshift lever.

14. The method according to claim 11, further comprising the step of casting-on the connecting pin for connecting a connecting cable control to the selector lever.
